(19) United States
(12) Patent Application Publication
(10) Pub. No.: US 2015/0341763 A1
(43) Pub. Date: Nov. 26, 2015

(54) ON HOLD DETECTION

(71) Applicant: Lenovo (Singapore) Pte. Ltd., Singapore (SG)

(72) Inventors: Nathan J. Peterson, Durham, NC (US); Bryan L. Young, Apex, NC (US); Jennifer Lee-Baron, Morrisville, NC (US); Amy Leigh Rose, Chapel Hill, NC (US); John Scott Crowe, Durham, NC (US)

(73) Assignee: Lenovo (Singapore) Pte. Ltd., Singapore (SG)

(21) Appl. No.: 14/284,677

(22) Filed: May 22, 2014

(51) Int. Cl. H04W 4/16; H04M 1/725; H04M 3/428

(52) U.S. Cl. CPC H04W 4/16; H04M 3/4285; H04M 3/4286; H04M 1/7253; H04W 88/02

(57) ABSTRACT

A method includes detecting when a call is placed on hold on a call enabled device by another party on the call, performing an action via the call enabled device based on detection that the call has been placed on hold, and detecting when the call is taken off of hold. A user of the call enabled device may be notified when the call has been taken off of hold.

### BACKGROUND

When a user of a device on a call is placed on hold during the call, the user may hear on hold music. The user needs to actively listen to realize that the hold has been released, and is not able to switch to other tasks without risking losing the call.

### SUMMARY

A method includes detecting when a call is placed on hold on a call enabled device by another party on the call, performing an action via the call enabled device based on detection that the call has been placed on hold, and detecting when the call is taken off of hold.

A machine readable storage device having instructions for execution by a processor of the machine to perform detecting when a call is placed on hold on a call enabled device, performing an action via the call enabled device based on detection that the call has been placed on hold, and detecting when the call is taken off of hold.

A device includes a processor and a memory device having a program stored thereon for execution by the processor to detect when a call is placed on hold on a call enabled device, perform an action via the call enabled device based on detection that the call has been placed on hold, and detect when the call is taken off of hold.

### BRIEF DESCRIPTION OF THE DRAWINGS

FIG. 1 is a block diagram of a system for detecting a call has been placed on hold according to an example embodiment.

FIG. 2 is a flowchart illustration of a method of detecting a call has been placed on hold according to an example embodiment.

FIG. 3 is a flowchart illustration of a further method of detecting a call has been placed on hold according to an example embodiment.

FIG. 4 is a block diagram of processing circuitry and software used to implement methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A call enabled device, such as a smart phone, cell phone, or other device on which a call may be handled and having or coupled to some processing capabilities is configured to detect when a call has been placed on hold. The detection may involve detecting tones generated by another device responsible for placing the call on hold, or the detection of on hold music. The device may then perform an action as a function of detecting that the call has been placed on hold. Such actions include but are not limited to releasing a wireless earpiece or speaker for other tasks, such as playing user selected music while the call is on hold, or informing a user of the device that the call is on hold allowing the user to use the device for other tasks or perform other tasks not using the device.

The call enabled device may continue to monitor the call and detect when the call has been taken off of hold. The detection may be based on specific tones, or discontinuation of the on hold music. Once detected, the call may be directed by the call enabled device back to the wireless earpiece or speaker, and may also include alerting the user that the call is back, and optionally placing the call on mute until the user directs otherwise. Some alerts include vibrating, ringing, lighting up the device or other methods.

One example using the call enabled device includes calling in early to a conference call and being automatically placed on hold until the organizer of the call joins. A switch or other computing device receives the call and places the caller on hold. The switch may provide on hold music while on hold and may additionally provide tones or a data signal indicating that the call has been placed on hold. When the call is taken off of hold, the switch may discontinue the on hold music and may additionally provide tones or a data signal indicating that the call is now connected to the conference.

The call enabled device may detect the tones or signals and the presence or absence of on hold music, and may inform a user appropriately. The call enabled device may also release a wireless device, such as a Bluetooth earpiece or speaker, for other tasks, such as playing music from the call enabled device or other device. When the call is taken off hold, the connection to the Bluetooth earpiece may be reestablished.

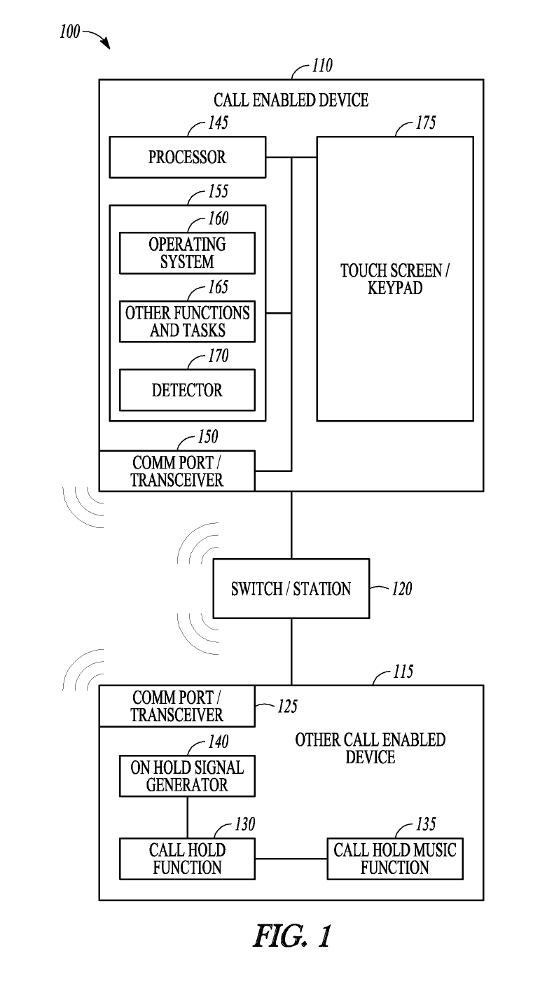

FIG. 1 is a block diagram of a system 100. System 100 includes a call enabled device 110, such as a cell phone, smart phone, or land line based phone coupled to processing circuitry as illustrated within device 100. An other call enabled device 115 is illustrated as connected to the call enabled device 110 via a switch or cellular station 120. The other call enabled device 115 may include a transceiver 125 to communicate in a wireless manner with other devices, a call hold function 130, an on hold music function 135, and an on hold signal generator 140. These functions may comprise software and a processor in various embodiments, which may be implemented in other call enabled device 115, or a switch 120 to which the device 115 is coupled.

Call enabled device 110 may comprises a processor 145 and a communication line 147 to couple the processor 145 to a communication port or transceiver 150, and a memory device 155, which may contain computer instructions for execution by processor 145 to implement an operating system 160, other functions and tasks 165, and a detector 170. Detector 170 may receive the tones, signals, or on hold music generated in association with the call being placed on hold, and when going off of on hold. In one embodiment, the detector may include an application that recognizes distinctive characteristics of on hold music to determine whether or not on hold music is present. Optionally, the detector 170 may be programmed to recognize special tones representative of being placed on hold and taken off of on hold. Still further, data channels may be monitored by the detector 170 to detect signals placed on one or more data channels representative of being placed on hold and taken off of on hold.

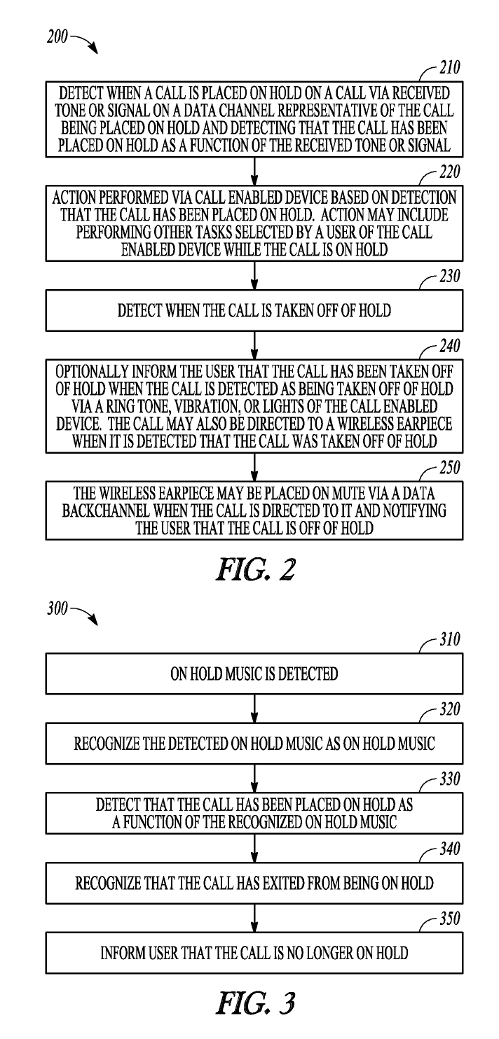

FIG. 2 is a flowchart illustrating a method 200 of detecting when a call has been placed on hold. At 210, method 200 detects when a call is placed on hold on a call enabled device by another party on the call. At 220, an action may be performed via the call enabled device based on detection that the call has been placed on hold. At 230, the method 200 detects when the call is taken off of hold.

Detecting when a call is placed on hold may include receiving a tone or signal on a data channel representative of the call being placed on hold and detecting that the call has been placed on hold as a function of the received tone or signal. For example, entry into on hold may correspond with a first tone or signal, and exit from on hold may correspond with a second tone that is the same or different than the first tone or signal. The action may include performing other tasks selected by a user of the call enabled device while the call is on hold such as playing user selected music audible to the user, or placing the call enabled device on mute. Still further, the volume of speakers in or coupled to the call enabled device may be turned down while the call is on hold.

At 240, method 200 may also include informing the user that the call has been taken off of hold when the call is detected as being taken off of hold. The user may be informed via a ring tone or vibration of the call enabled device. The call may also be directed to a wireless earpiece when it is detected that the call was taken off of hold. At 250, the wireless earpiece may be placed on mute when the call is directed to it and notifying the user that the call is off of hold. Control of the wireless earpiece, such as a Bluetooth enabled earpiece or speaker may be accomplished via a data backchannel.

FIG. 3 is a flowchart illustrating a method 300 of detecting when a call is placed on hold. At 310, on hold music is detected. At 320, the method 300 recognizes the detected on hold music as on hold music. Method 300 then determines at 330 that the call has been placed on hold as a function of the recognized on hold music. One example application that recognizes music includes SoundHound. By recognizing a song that is playing, the application may be used or adapted to detect that music is being played by producing a positive recognition of a song. When no music is playing, a simple sound detector can determine the lack of sound and associate the lack of sound with the call being taken off of on hold after a selected time, such as a few seconds of silence. Further methods of detecting on hold music may include the use of frequency domain heuristics implemented by code than may be loaded into legacy smart phones. At 340, method 300 may recognize that the call has exited from being on hold, and at 350, may inform the user that the call is no longer on hold.

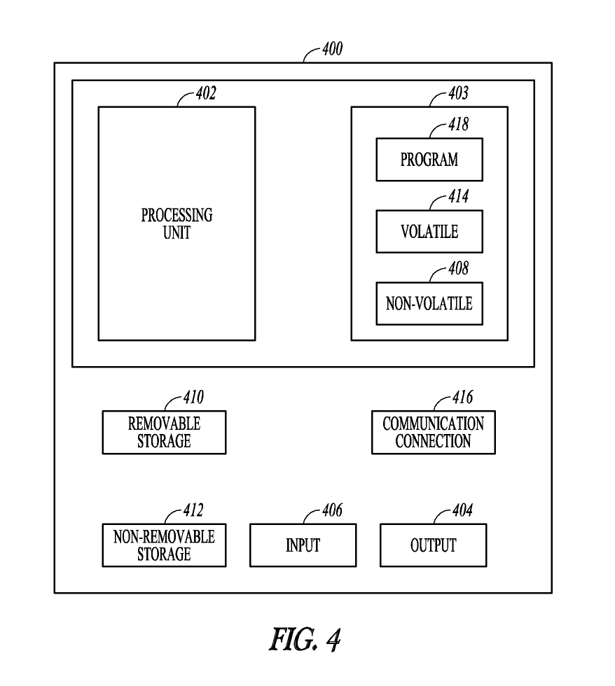

FIG. 4 is a block schematic diagram of a telephone like device, such as a smart phone or other telephone with some intelligence integrated or coupled to it to perform the methods described herein. The device is described as a computer system 400 having processing circuitry and software. All components need not be used in various embodiments. One example computing device in the form of a computer 400 may include a processing unit 402, memory 403, removable storage 410, and non-removable storage 412. Sensors 115 and 125 may be coupled to provide data to the processing unit 402. Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 400 may include or have access to a computing environment that includes input 406, output 404, and a communication connection 416. Output 404 may include a display device, such as a touchscreen, that also may serve as an input device. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), a cellular network, or other networks.

Computer-readable instructions stored on a computer-readable medium are executable by the processing unit 402 of the computer 400. A hard drive, CD-ROM, and RAM are some examples of articles including a non-transitory computer-readable medium. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

### Examples

1. A method comprising:
detecting when a call is placed on hold on a call enabled device by another party on the call;
performing an action via the call enabled device based on detection that the call has been placed on hold; and
detecting when the call is taken off of hold.

2. The method of example 1 wherein the action comprises performing other tasks selected by a user of the call enabled device while the call is on hold.

3. The method of example 2 wherein the action comprises playing user selected music audible to the user.

4. The method of any of examples 1-3 wherein the action comprises placing the call enabled device on mute.

5. The method of any of examples 1-4 and further comprising informing the user that the call has been taken off of hold when the call is detected as being taken off of hold.

6. The method of example 5 wherein the user is informed via one or more of a ring tone or vibration of the call enabled device.

7. The method of any of examples 1-6 and further comprising directing the call to a wireless earpiece when it is detected that the call was taken off of hold.

8. The method of example 7 and further comprising placing the wireless earpiece on mute when the call is directed to it and notifying the user that the call is off of hold.

9. The method of any of examples 1-8 wherein detecting when a call is placed on hold comprises:
receiving on hold music;
recognizing the on hold music as on hold music; and
detecting that the call has been placed on hold as a function of the recognized on hold music.

10. The method of any of examples 1-8 wherein detecting when a call is placed on hold comprises:
receiving a tone representative of the call being placed on hold; and
detecting that the call has been placed on hold as a function of the received tone.

11. A machine readable storage device having instructions for execution by a processor of the machine to perform:
detecting when a call is placed on hold on a call enabled device;
performing an action via the call enabled device based on detection that the call has been placed on hold; and
detecting when the call is taken off of hold.

12. The machine readable storage device of example 11 wherein the action comprises performing other tasks selected by a user of the call enabled device while the call is on hold.

13. The machine readable storage device of any of examples 11-12 and further performing informing the user that the call has been taken off of hold when the call is detected as being taken off of hold.

14. The machine readable storage device of any of examples 11-13 and further performing directing the call to a wireless earpiece when it is detected that the call was taken off of hold.

15. The machine readable storage device of example 14 and further performing placing the wireless earpiece on mute when the call is directed to it and notifying the user that the call is off of hold.

16. The machine readable storage device of any of examples 11-15 wherein detecting when a call is placed on hold comprises:
receiving on hold music;
recognizing the on hold music as on hold music; and detecting that the call has been placed on hold as a function of the recognized on hold music.

17. The machine readable storage device of any of examples 11-15 wherein detecting when a call is placed on hold comprises:
receiving a tone representative of the call being placed on hold; and
detecting that the call has been placed on hold as a function of the received tone.

18. A device comprising:
a processor; and
a memory device having a program stored thereon for execution by the processor to:
detect when a call is placed on hold on a call enabled device;
perform an action via the call enabled device based on detection that the call has been placed on hold; and
detect when the call is taken off of hold.

19. The device example 18 wherein the processor further detects when a call is placed on hold by:
receiving on hold music;
recognizing the on hold music as on hold music; and
detecting that the call has been placed on hold as a function of the recognized on hold music.

20. The device of example 18 wherein the processor further detects when a call is placed on hold by:
receiving a tone representative of the call being placed on hold; and
detecting that the call has been placed on hold as a function of the received tone.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
detecting when a call is placed on hold on a call enabled device by another party on the call;
performing an action via the call enabled device based on detection that the call has been placed on hold; and
detecting when the call is taken off of hold.

2. The method of claim 1 wherein the action comprises performing other tasks selected by a user of the call enabled device while the call is on hold.

3. The method of claim 2 wherein the action comprises playing user selected music audible to the user.

4. The method of claim 1 wherein the action comprises placing the call enabled device on mute.

5. The method of claim 1 and further comprising informing the user that the call has been taken off of hold when the call is detected as being taken off of hold.

6. The method of claim 5 wherein the user is informed via one or more of a ring tone or vibration of the call enabled device.

7. The method of claim 1 and further comprising directing the call to a wireless earpiece when it is detected that the call was taken off of hold.

8. The method of claim 7 and further comprising placing the wireless earpiece on mute when the call is directed to it and notifying the user that the call is off of hold.

9. The method of claim 1 wherein detecting when a call is placed on hold comprises:
receiving on hold music;
recognizing the on hold music as on hold music; and
detecting that the call has been placed on hold as a function of the recognized on hold music.

10. The method of claim 1 wherein detecting when a call is placed on hold comprises:
receiving a tone representative of the call being placed on hold; and
detecting that the call has been placed on hold as a function of the received tone.

11. A machine readable storage device having instructions for execution by a processor of the machine to perform:
detecting when a call is placed on hold on a call enabled device;
performing an action via the call enabled device based on detection that the call has been placed on hold; and
detecting when the call is taken off of hold.

12. The machine readable storage device of claim 11 wherein the action comprises performing other tasks selected by a user of the call enabled device while the call is on hold.

13. The machine readable storage device of claim 11 and further performing informing the user that the call has been taken off of hold when the call is detected as being taken off of hold.

14. The machine readable storage device of claim 11 and further performing directing the call to a wireless earpiece when it is detected that the call was taken off of hold.

15. The machine readable storage device of claim 14 and further performing placing the wireless earpiece on mute when the call is directed to it and notifying the user that the call is off of hold.

16. The machine readable storage device of claim 11 wherein detecting when a call is placed on hold comprises:
receiving on hold music;
recognizing the on hold music as on hold music; and
detecting that the call has been placed on hold as a function of the recognized on hold music.

17. The machine readable storage device of claim 11 wherein detecting when a call is placed on hold comprises:
receiving a tone representative of the call being placed on hold; and
detecting that the call has been placed on hold as a function of the received tone.

18. A device comprising:
a processor; and
a memory device having a program stored thereon for execution by the processor to:
detect when a call is placed on hold on a call enabled device;
perform an action via the call enabled device based on detection that the call has been placed on hold; and
detect when the call is taken off of hold.

19. The device of claim 18 wherein the processor further detects when a call is placed on hold by:
receiving on hold music;
recognizing the on hold music as on hold music; and
detecting that the call has been placed on hold as a function of the recognized on hold music.

20. The device of claim 18 wherein the processor further detects when a call is placed on hold by:
receiving a tone representative of the call being placed on hold; and
detecting that the call has been placed on hold as a function of the received tone.
